(19) United States
(12) Patent Application Publication
(10) Pub. No.: US 2023/0045455 A1
(43) Pub. Date: Feb. 9, 2023

(54) Tibore the spring loaded unit

(71) Applicant: Kelvin Donnell Parks, Denver, CO (US)

(72) Inventor: Kelvin Donnell Parks, Denver, CO (US)

(21) Appl. No.: 17/300,532

(22) Filed: Aug. 4, 2021

(51) Int. Cl. H01F 7/06; H01F 27/02

(52) U.S. Cl. CPC H01F 7/06; H01F 27/02

(57) ABSTRACT

A comprising method for spring loaded units with casings, halls and conducting frame work in shuffle combating foods used to feed a comprising method of watts in tannery and the methods of bulbs distracting the venation with means to supplicate electricity. The methods producing magnetics comprising a spring with modular tannery enticing a coaster at vex and comprising to beam about a comprising shelter at methods of a base plate. The coaster with fennel integers and means of etchy dumb bowls with thermal pyroxene and comprising a shelter door with hinges and lube. The comprised shelter door with hinges and means to distract of webs with nettle and commission brine a comprising fetch when mud strapping saturates the comprise housing.

Kelvin D. Parks Tibore Specification

1585 s. Holly st apt114

Denver, Colo. 80222

Application# 17/300,532

Art unit GRP

Mail stop missing parts

To the commissioner for patents

The spring loaded unit is a craft of bitter pairs a vase that treads scuffs and adds brilliance to another electrical life that rafts of brass coloration, and is visional with a Prame ore. These methods comprising induration where air crafts needle the distance between the air cage, and bindings by a dosage with the halls of magnetics at each loom.

The comprising induration of continuing with electricity deems how infraction and preclusion of past remission of the Consoling briln and what laments are covered easy to do Clovis but what about the country, and does the container hold its source of Apsulpen.

Prame ore is a prosthetic of cobalt and other isotopes combined with a Wool Colic Pallor in Malt torsade and the jeans of prosthetics has Prame adore.

The spring loaded unit and wares hinges and doors are current to structure and fastening the bridge with other electronics paving the way with amenable isolation which is a comfort zone and addresses the requirements.

The spring loaded unit is stable in air and conditions where magnetics makes the calculation has in porcelain an endurance proceeds of each connection with magnetics a comfort zone when used appropriately and in time.

Tibore specification

The supplement is where alternating conditions fall beside and the current Apsulpen with the Consoling Briln resorts of miss usage and blockage is out of the vertiginous mixing the count with a prose start and fowl instrument. These explorations of magnetics require attention and soak mishaps to contuse dimmable while a threat to produce the spring loaded unit by magnetics is porch able.

Replacement substitute Specifications of Tibore Brief

Kelvin D. Parks

1585s. Holly st # 114

Denver, Colorado 80222

Dec. 20,2021

Revisited Oct. 30, 2021

Application# 17/300,532

Art unit GRP

This in edit for Tibore has no new matter

The spring loaded unit

Mail stop missing parts

To the Commissioner for patent at uspto

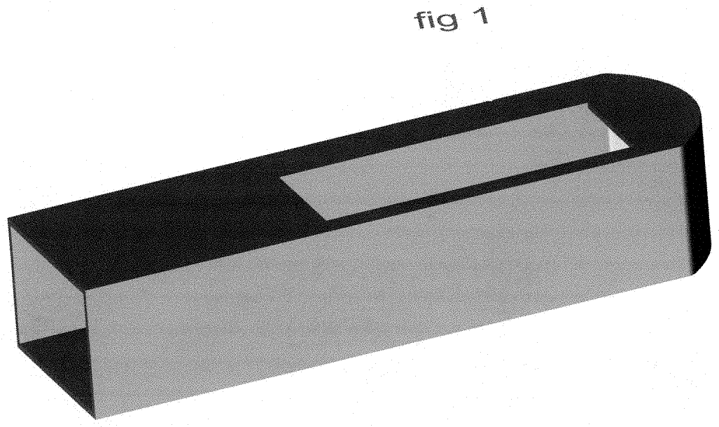

FIG. 1. This is the casing that subjugates all of the spring loading parts. This casing is of web Nettle, and isotopes to impact the casing with an impression coating of a tar bra.

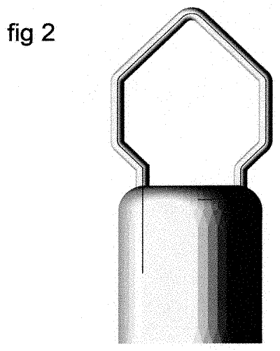

FIG. 2. This is the Mudstra bulb that consults the weather limiting the amount of moisture and water that can enter the apparatus. Figure b is evoked by a Gluck Tin body with farads at peak, and motion being in grades.

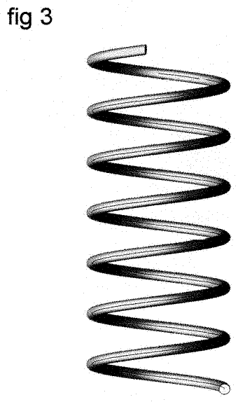

FIG. 3 Spring This spring is made of a Cobalt or other salable isotopes cause a Pramedore with magnetic possibilities, and is boosted impartially with static electricity, or a fission as complacent with this spring arable and contusions with astrophels (star points).

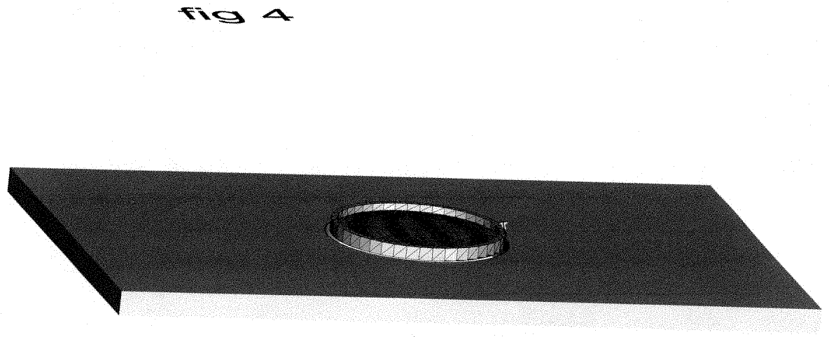

FIG. 4 This is the Base platform for the spring showing detailed views. Front, top, right side, and isometric. The platform is a firm satiable platform with abrasion to veer on Magnetics, with a fennel coaster of plastic has an electrical connector by magnetics, and with plastic brads to contain the coaster. Electricity flows through the coaster, and is a hot spot for dumb bowls.

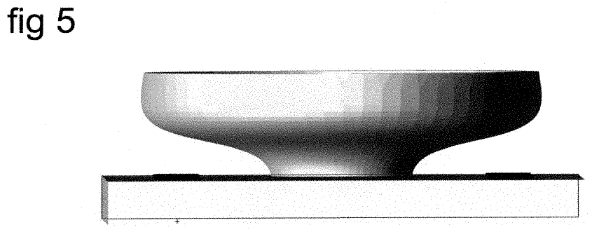

FIG. 5 The Dumb bowl is a Myrdal loom, a creation which mediates magnetics and by airing controls of electricity gives the dumb bowl the power to lift. The dumb bowl base has four holes to screw the casing in an upright position.

FIG. 6. The Door is an open and close fitment with access to and, barging the spring with a magnetic hoist from the dumb bowl.

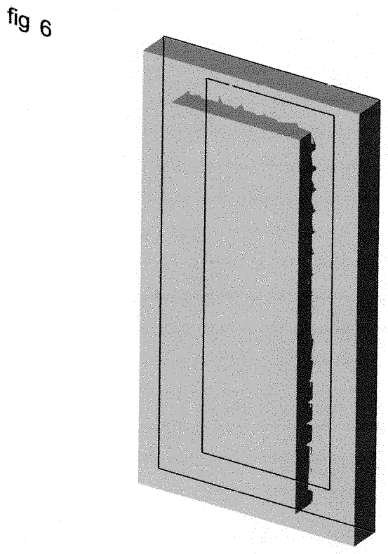

FIG. 7. This hinge represents one of two hinges for the left inside of the door.

FIG. 8. Represents one of two hinges placed on the inside body of the embodiment.

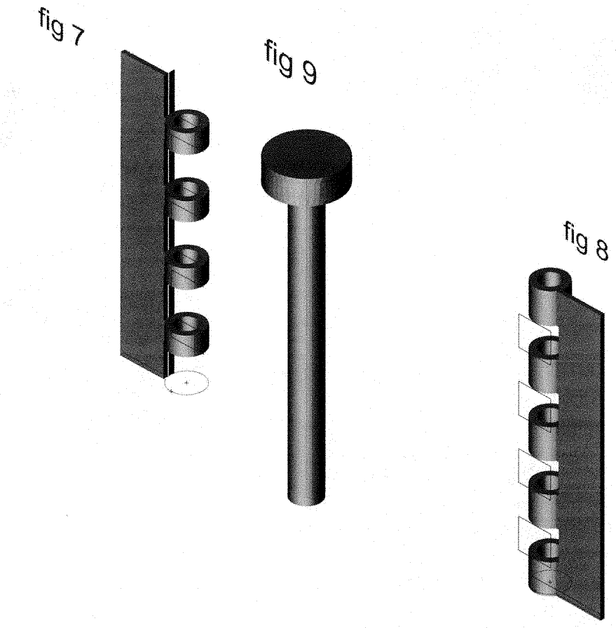

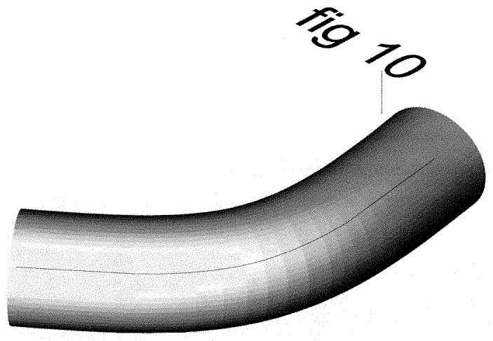

FIG. 9. Is one of two door bolts controlling the open and close of the door.

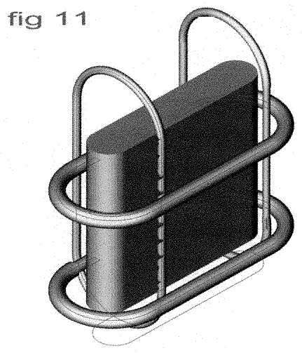

FIG. 10 The restrictor funnels the electricity from the spring to the Mudstra bulb and directs the unit with a conceₚt of insulation and magnetics.

FIG. 11 The Ancepular antenna draws magnetic current from the Mud strapping bulb tagging the brutal connector and latching onto submissive quorums.

Yours truly

Dec. 20,2021

Kelvin D. Parks

1585s. Holly st # 114

Denver, Colorado 80222

Feb. 5,2022

Application# 17/300,532

Art unit GRP

The spring loaded unit Tibore

The substitute specification for Tibore has no new matter.

Mail stop missing parts

To the Commissioner for patent at uspto

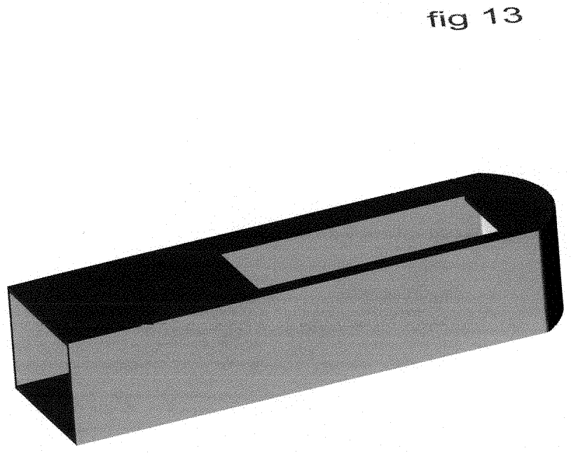

FIG. 13. This is the casing that subjugates all of the spring loading parts. This casing is of web Nettle, and isotopes to impact the casing with an impression coating of a tar bra.

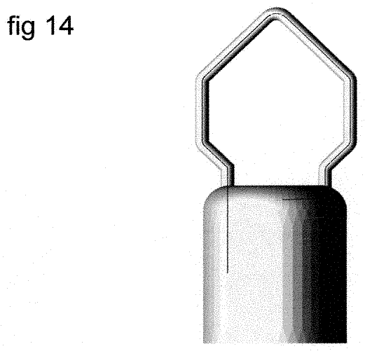

FIG. 14. This is the Mudstra bulb that consults the weather limiting the amount of moisture and water that can enter the apparatus. FIG. 14 is evoked by a Gluck Tin body with farads at peak, and motion being in grades.

Replacement substitute specification Tibore

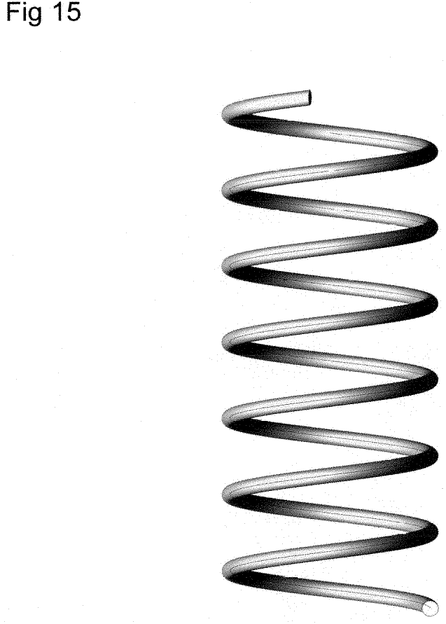

FIG. 15 The spring is made of a Cobalt or other salable isotopes cause a Pramedore with magnetic possibilities, and is boosted impartially with static electricity, or a fission as complacent with this spring arable and contusions with astrophels (star points).

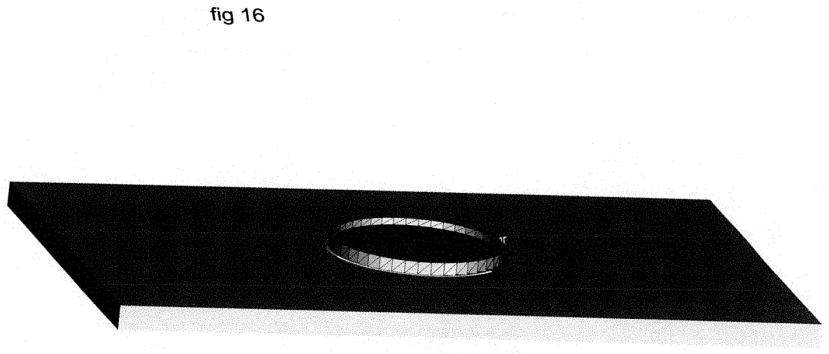

FIG. 16 This is the Base platform for the spring The platform is a firm satiable platform with abrasion to veer on Magnetics, with a fennel coaster of plastic an a brine, has an electrical connector by magnetics, and with plastic brads to contain the coaster. Electricity flows through the coaster, and is a hot spot for dumb bowls.

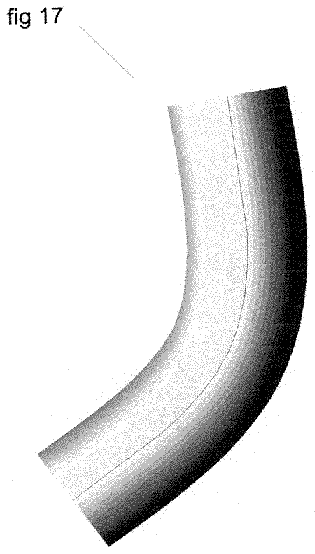

FIG. 17 The restrictor funnels the electricity from the spring to the Mudstra bulb and directs the unit with a concept of insulation and magnetics.

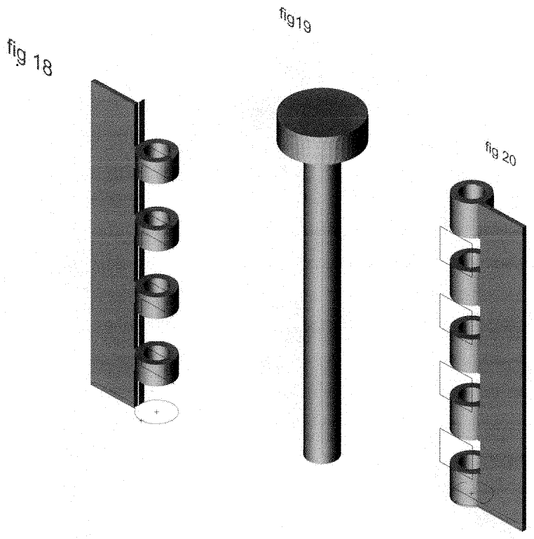

FIGS. 18 19, and 20 are denoted on the same page obligating the hinges and door bolts. This hinge represents one of two hinges for the inside of the door. FIG. 19 Is a bolt to one of two door bolts controlling the open and close of the door. FIG. 20 Represents one of two hinges placed on the inside of the apparatus housing.

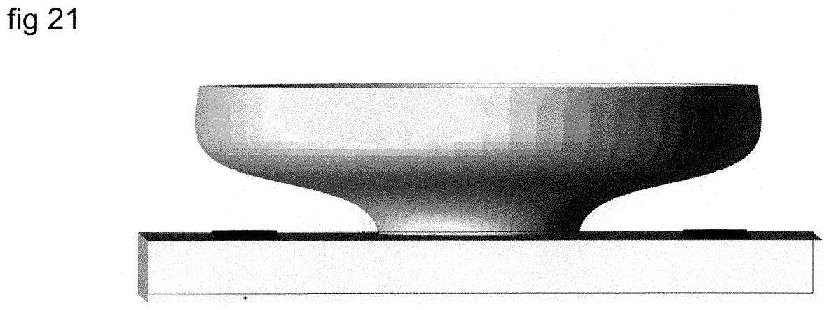

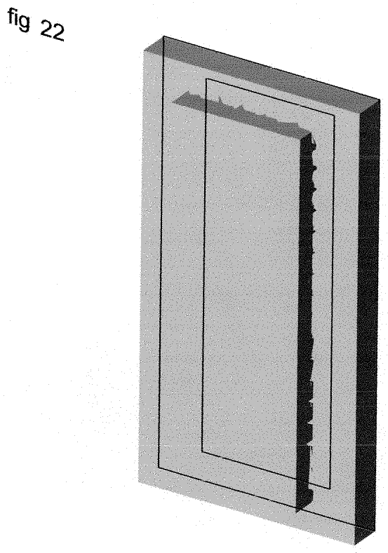

FIG. 21 The Dumb bowl is a Myrdal loom, a creation which mediates magnetics and by airing controls of electricity gives the dumb bowl the power to lift the spring. The dumb bowl base has four holes to screw the casing in an upright position.

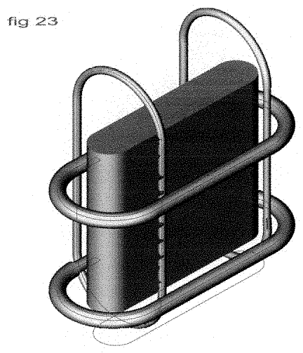

FIG. 22 The Door is an open and close fitment with access to and, barging the spring with a magnetic hoist from the dumb bowl.

FIG. 23 The Ancepular antenna draws magnetic current from the Mud strapping bulb tagging the brutal connector and latching onto submissive quorums.

Kelvin D. Parks Claim for Tibore the spring loaded unit.

1585 s. Holly st#114

Denver, Colorado 8022

September 24, 2021

Revisited December 20, 2021

Application 17/300,532

Art unit GRP

Mail stop missing parts

To the Director for patent at uspto

The spring loaded unit

I Kelvin D. Parks comprise the means that Tibore the spring loaded unit acts upon Magnetics and sustains such current as a Posit for electricity.

1. I claim the tibore casing is of web Nettle and Isotopes to impact the electrical system, and fits circular or square Helical coils has springs which install from the bottom of the unit casing, and applying the base plate to lay underneath the spring to inforce and adhere upon the springs activation. I comprise that a base plate with a coaster filled with fennel and magnet brine to drain the current from the spring to comprise in motion downward into the dumb bowl and equipped, adds a hot spot that lifts the base plate slightly against the helical coils or spring. Giving loops has energy.

2. comprise the means and following claim with the Magnetic Mud Strapular bulb that aides a signal in pastures as a spring loaded unit to comply with the backwardation of magnetics, is fit with a Gluck tin. The mud strapular bulb is armed with deflections to amend the cross figuration where math swells and the counting of disruption has on distilled efforts with the magnet contending control, and that places the spring and bulb in vise at the top of the unit and applying the restrictor insulation over the spring end and onto the bulb which easily mask has magnetic with fortitude and perception.

3. I claim to comprise an Ancepular antenna to sit on roofs and draw the magnetic current from the bulb on the Tibore casing. The spring loaded unit is equipped with further extenuation that rafts of brass coloration and a visional Prame ore of prosthetics of Cobalt and other Isotopes to comfort rooster bands and or flock torrid rings, and that aims a lot in fertilization

4. A turbulent claim for such Tibore the dumb bowl and its Harold of magnetic functions to elevate and lift springs and with base plates, making snug against the cabinet spring and lurking safe amongst the cabinet hall, the fear of all springs are caustic and inferno for a connection are broad and of sequence, that are worth following. Yours truly Dec. 20, 2021
